(19) United States
(12) Patent Application Publication
(10) Pub. No.: US 2007/0087209 A1
(43) Pub. Date: Apr. 19, 2007

(54) Plastic-metal composite material with wire gauze

(75) Inventors: Christian Farhumand, Neunkirchen-Seelscheid (DE); Georgios Tziovaras, Wuppertal (DE); Matthias Boll, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/580,503

(22) Filed: Oct. 13, 2006

(30) Foreign Application Priority Data
Oct. 15, 2005 (DE) 102005049447.1

(51) Int. Cl. B32B 15/08

(52) U.S. Cl. 428/458

(57) ABSTRACT

A plastic-metal composite material, in particular a transparent plastic-metal composite material, based on a thermoplastic polymer with a wire gauze made from extremely fine wire is described, for use in particular for electromagnetic shielding or for mechanically reinforced windows.

### CROSS REFERENCE TO RELATED APPLICATION

This application claims priority under 35 U.S.C. §119(a-e) to German application DE 10 2005 049447.1, filed Oct. 15, 2005.

### FIELD OF THE INVENTION

The invention concerns a plastic-metal composite material, in particular a transparent plastic-metal composite material, based on a thermoplastic polymer with a wire gauze made from extremely fine wire, for use in particular for electromagnetic shielding or for the mechanical reinforcement of components having a high optical quality.

### BACKGROUND OF THE INVENTION

In many areas of daily life it is important to use components which on the one hand provide mechanical protection and on the other ensure optical transparency. Examples include bullet-proof or shatterproof glass for cars or buildings, protective goggles for elevated protection requirements or automatic teller machines and vending machines in which the goods must be visible and should at the same time be protected against theft and vandalism.

Thus the equipping of transparent glass sheets, e.g. safety glass sheets, with a coarse wire cloth, which gives the sheet a greater fracture resistance and prevents it from shattering into large sharp-edged pieces, in order to minimise the risk of injury if the sheet were to break, is known in principle. The disadvantage of such safety glass sheets is the disruption in transparency due to the wiring, and the heavy weight.

Other solutions available hitherto consist of thick composite glass (a successor to glass sheets with an interlayer of transparent plastic film) and are therefore very heavy in principle, and because of the thickness of the materials optical distortion is almost inevitable. Despite these obvious disadvantages, these sheets are used in automotive construction if the vehicles are intended for use in crisis areas.

In such safety glass sheets, which should allow a free and as clear a view as possible, the broken glass is held together by the embedded film if an accident occurs. Typical applications are car windows, train windows and security windows in banks. In order to reduce the weight, plastic safety sheeting is occasionally also used, especially in applications such as safety visors and the like. Shields for the police and military are comparatively heavy with a moderate safety effect, so there is a need here for lighter shields with an improved protective effect. The use of the present novel development should allow them to be made thinner with a simultaneously improved protective effect, making them lighter and safer.

The mechanical stability of safety visors is frequently regarded as still inadequate, however, and there is therefore a need to find solutions combining mechanical stability, optical transparency and reduced weight.

In the area of electromagnetic shielding or reflection, plastic components could not be used before now because of their low electrical conductivity. Plastics doped with conductive materials (for example with conductive carbon black) have an electrical conductivity which is too low by several orders of magnitude to ensure an effective electromagnetic shielding. They are used to prevent electrostatic charging. The object of electromagnetic shielding or reflection is currently achieved by the use of metal grids, metal plates or metallic paints, which have optically disruptive properties (in other words they are only partially transparent or are completely non-transparent). In the area of microwave ovens, glass is largely used at present into which perforated metal sheet is incorporated or onto which stripes or other patterns are applied with a conductive paste and are baked in.

Housings of electrical appliances which react sensitively to interference from electromagnetic radiation (for example due to adjacent strong alternating electrical fields) currently have to be made from metal or painted with an electrically conductive paint, giving rise to corresponding disadvantages in terms of design, weight and price and in some cases also environmental protection. The reflection of electromagnetic radiation (for example the field of view of a microwave oven) could hitherto likewise not be achieved with plastics. Design changes which can also lead to technical advantages (curving of the front window to focus radiation on the turntable, etc.) are impossible or achievable only with difficulty.

Parabolic antennae, which are used for example for transmission and reception in the microwave range for radio and television, including in the home, are currently made almost exclusively using metal sheets which have been bent or pressed into the appropriate shapes. The use of sheet metal involves optical disadvantages: installed satellite dishes severely spoil the visual appearance of the buildings to which they are attached. It should be possible to combine extremely high transparency and outstanding functionality (reflection of microwaves) with high impact resistance and good weather resistance through the plastic that is used. The visually disruptive appearance of the parabolic reflector should be able to be reduced in this way.

To make the surface of plastics conductive (in order to prevent electrostatic charging, as is necessary in explosion-proof areas), electrically conductive materials (e.g. conductive carbon blacks) have hitherto always been added to the plastics. A low electrical conductivity can be achieved in this way which is sufficient to dissipate the electrical surface charge. Due to the conductive carbon black filler content, however, the plastics used are always non-transparent and are generally black.

### SUMMARY OF THE INVENTION

The object of the present invention is therefore to provide a composite material, in particular for mechanically reinforced windows or for the electromagnetic shielding of optically transparent components, which can be produced in a simple manner and combines good mechanical properties with low weight and in particular optical transparency.

The object is achieved by providing conventional plastic material, in particular transparent plastic films, plastic mouldings or film laminates, with a scarcely noticeable wire gauze made from extremely fine wire.

The invention provides a plastic-metal composite material based on a thermoplastic polymer with a wire gauze made from extremely fine wire, the composite material being at least partially optically transparent.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The wire gauze can be a woven or knitted fabric made from extremely fine wire or an intersecting mesh comprising at least two layers of extremely fine wires positioned parallel to one another, the layers being glued, welded or sintered together at the points of intersection of the wires.

The weight problem is resolved by the use of e.g. polycarbonate instead of glass. A fine, thin cloth, for example, made from a metal or a metal alloy is used for mechanical. reinforcement. The mesh size is around 100 μm, for example, and the wire thickness around 20 μm, for example. This produces a close-mesh wire gauze which can scarcely be discerned by the human eye and which merely reduces the light passing through, without allowing the individual structures of the wires to be visually discerned.

The wire gauze is applied to a polycarbonate film, for example, by attaching it with a glue or paint or by softening the underlying PC film using solvents capable of partially dissolving polycarbonate.

The plastic-metal composite material preferably contains at least one plastic film.

In a preferred variant of the plastic-metal composite material, the wire gauze is embedded in the polymer or bonded to the surface of the polymer, in particular to the plastic film.

The wire gauze can also be attached by lamination, e.g. between two PC films, including at elevated temperature. After the wires have been attached, the film obtained can still be mechanically shaped within certain limits (e.g. by thermoforming).

A plastic-metal composite material is particularly preferred which is characterised in that the plastic-metal composite material has a multilayer structure with at least two plastic films and the wire gauze is enclosed, in particular laminated, between two plastic films.

A further variant of the plastic-metal composite material is characterised in that the plastic-metal composite material is formed by one or more plastic films and that the plastic-metal composite material as a whole can be thermoformed.

The film obtained in this way can undergo further treatment by a back-moulding process, preferably on the side facing away from the plastic film. In suitable machines the back-moulding process can even be carried out without the wire mesh being directly attached to the film.

Alternatively, sheets or profiles can likewise be laminated with the wire gauze using extrusion processes.

Through the use of a fine wire gauze made from metal or a metal alloy and incorporation thereof in plastic, for example polycarbonate or another, preferably optically transparent, plastic, the plastic can be mechanically strengthened. The effect is more or less clearly marked depending on the mesh size and wire thickness.

In a further preferred embodiment the plastic-metal composite material therefore additionally has at least one section made from injection-moulded plastic.

Another preferred embodiment of the plastic-metal composite material exhibits injection-moulded sections made from both transparent and non-transparent plastic.

As the thermoplastic polymer for the plastic film and/or the injection-moulded plastic, a polymer is preferably selected from the series comprising polycarbonate, polyacrylate, in particular polymethyl methacrylate, polyester, in particular polyethylene terephthalate, polyalkylene, in particular polypropylene.

Iron wire, in particular steel wire, or tungsten wire is preferably used as the material for the extremely fine wire.

The extremely fine wire preferably has a diameter of at most 100 μm, preferably 5 to 50 μm, particularly preferably 10 to 30 μm.

The mesh size of the wire gauze is preferably 50 μm to 20 mm, particularly preferably 80 μm to 5 mm, most particularly preferably 80 μm to 1 mm.

The aforementioned selection gives rise to a wire gauze which can scarcely be discerned by the human eye and which merely reduces the light passing through, without allowing the individual structures of the wires to be visually discerned.

The wire gauze is preferably sintered before being attached to the polymer.

As textures for the wire gauze, all known textures are suitable, in particular the known weaves, preferably basket weave, single plain weave, reverse plain Dutch weave, twill and Dutch twilled weave.

To minimise light reflections on the shiny metal surface of the wire gauze, the wire to be incorporated should first be matted. This can be achieved in various ways, for example by an etching process, which precedes the actual incorporation into the plastic or the injection-moulding process, or by heat treatment of the wire gauze under air, so that a thin layer of metal oxide forms on the wire which scatters the incident light diffusely and not directionally.

A particularly suitable, preferred arrangement is the wave-shaped, in particular regularly wave-shaped or square wave-shaped arrangement of the wires in the wire mesh. This arrangement can be achieved using special programmable wire inserting machines.

The invention also provides the use of the plastic-metal composite material according to the invention as a mechanically reinforced window, in particular for vehicle windows, safety helmets and shields, or as a mechanically reinforced insert, in particular for equipping protective clothing.

Through the use of a fine electrically conductive wire gauze, consisting for example of metal or a metal alloy, and incorporation in the plastic, the plastic-metal composite material can also be used to shield or reflect electromagnetic radiation. Depending on the mesh size, different wavelengths can be reflected. The mesh size should be in the same order of magnitude as or below the desired wavelength, in order to ensure as effective as possible a reflection of the electromagnetic radiation. A fine, thin weave consisting of a metal or metal alloy, preferably stainless steel or tungsten, is preferably used for electromagnetic shielding.

The invention also provides the use of the plastic-metal composite material according to the invention as an optically transparent, electromagnetic shielding or as an electromagnetic reflector, in particular for domestic appliances, e.g. microwave ovens, and for parabolic antennae.

### EXAMPLES

### Example 1

A stainless steel gauze (stainless steel grade 1.4306) with a wire thickness of 20 μm and a mesh size of 100 μm, is inserted between two 375 μm thick polycarbonate films (Makrofol®, manufactured by Bayer MaterialScience AG) and laminated for 10 minutes at 185° C. under a pressure of 300 N/cm². The film composite obtained in this way is back-moulded with polycarbonate to produce 2 mm thick sheets.

The sheets demonstrate an improvement in puncture resistance as compared with unmodified PC sheeting of the same density.

### Example 2

Tungsten wires (with a diameter of 20 μm) are arranged in two layers vertically on top of one another on a 375 μm thick polycarbonate film (Makrofol®). The wires lying on top of the film are first fixed to the film by applying small drops of dioxalane to the points of intersection of the individual wires. The dioxalane initially partially dissolves the polycarbonate on the surface of the film but then evaporates again, so that a thin layer of polycarbonate remains on the wires, ensuring a sufficiently stable bond with the film.

A UV-curing polyurethane-based paint was used to fix the wires to the film and at the same time to provide mechanical protection for the wires. The wires exhibited good adhesion to the surface, which was sufficient to introduce the film into a back-injection mould and to back-mould it with polycarbonate. In this way the wires were completely enclosed in polycarbonate and the workpiece exhibits virtually no background distortion when looked through. Back-moulding can also be carried out without prior painting.

The film can, as described above, either be back-moulded directly on the side to which the wire is attached or on the side facing away from the wire, or can be treated with various paint systems.

In another experiment the wires are arranged not in one layer in straight lines but in a wave-shaped manner, because this produces further optical advantages: through this arrangement the wires are only just visible and can scarcely be seen with the human eye. With the wave-shaped arrangement, even the only slight remaining optical distortion caused by the use of the fine wires when the sheet is looked through disappears almost entirely.

### Example 3

A composite of two films with a wire gauze as described in Example 1 was tested with regard to its properties and compared with a wireless film and a composite with a larger-mesh wire gauze.

The films were incorporated into a section of waveguide and the material-dependent damping of microwave radiation was determined.

In the frequency range under consideration (microwaves of frequency 2.2 to 2.7 GHz), transmission through the films is not dependent on the frequency (in the context of the measuring accuracy of +/−5%).

The pure PC film produced an average transmission of 95%.

A film laminate consisting of two films with a wire gauze having a coarse mesh (mesh size 5 mm) made from tungsten wire (20 μm) between the two films displayed an average transmission of 25%.

A film back-moulded with polycarbonate (5 mm) with a wire gauze having a fine mesh (mesh size 100 μm) made from tungsten wire (20 μm) exhibited a transmission of 0% (+noise).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

### Example 4

One sample produced according to Example 1 and then back-moulded and two samples produced according to Example 2 and then back-moulded were examined for their reflection properties at high microwave frequencies corresponding approximately to the radiation frequency of commercial satellite dishes. The signal of a microwave detector was recorded on changing the distance between the sensor and the sample (measurement of the standing wave).

The signal paths of the samples to be examined were compared with the reflection from metal and a zero sample. The samples and the zero sample were sealed on their rear sides with an absorber material in order to create optimum measuring conditions.

The frequencies used were 12.5 GHz and 15 GHz.

Reproducibility was examined at 15 GHz in all of the samples.

For this purpose in each case 10 different, arbitrarily selected measuring positions were compared with each other, while varying the measurement sites and the polarization directions of the microwaves.

All of the samples displayed very good reproducibility.

The first sample with an embedded metal wire fabric with a mesh size of 200 μm and a wire thickness of 20 μm displayed reflection which was directly comparable to the reflection from a metal sheet in the wavelength range employed.

A second and a third sample produced in each case according to Example 2 with a mesh size of 1 mm and a wire thickness of 19 μm were also measured by the above procedure. The wires used consisted of stainless steel. Both samples displayed very good reflection properties which suggest their suitability for use as starting materials for transparent satellite dishes.

What is claimed is:

1. Plastic-metal composite material comprising a thermoplastic polymer and a wire gauze consisting of extremely fine wire, wherein the composite material is at least partially optically transparent.

2. Plastic-metal composite material according to claim 1, wherein the thermoplastic polymer is comprised of at least one plastic film.

3. Plastic-metal composite material according to claim 1, wherein the wire gauze is embedded in the thermoplastic polymer or is bonded to the surface of the thermoplastic polymer.

4. Plastic-metal composite material according to claim 1, wherein the plastic-metal composite material has a multilayer structure and the wire gauze is enclosed between two plastic films.

5. Plastic-metal composite material according to claim 1, wherein the plastic-metal composite material is formed from one or more plastic films and can be thermoformed.

6. Plastic-metal composite material according to claim 1, wherein the plastic-metal composite material further comprises at least one section consisting of injection-moulded plastic.

7. Plastic-metal composite material according to claim 1, wherein the plastic-metal composite material has injection-moulded sections consisting of transparent and non-transparent plastic.

8. Plastic-metal composite material according to claim 1, wherein the thermoplastic polymer for the plastic film and/or the injection-moulded plastic is a polymer selected from the group consisting of polycarbonate, polyacrylate, polyester and polyalkylene.

9. Plastic-metal composite material according to claim 1, wherein iron wire or tungsten wire is used as the material for the extremely fine wire.

10. Plastic-metal composite material according to claim 1, wherein the extremely fine wire has a diameter of at most 100 μm.

11. Plastic-metal composite material according to claim 1, wherein the mesh size of the wire gauze is 50 μm to 20 mm.

12. An optically transparent electromagnetic shielding or an electromagnetic reflector comprising the plastic-metal composite material according to claim 1.

13. A mechanically reinforced window, safety helmet and/or shield comprising the plastic-metal composite material according to claim 1.

14. A mechanically reinforced insert for protective clothing comprising the plastic-metal composite material according to claim 1.
